(19) United States
(12) Patent Application Publication
(10) Pub. No.: US 2013/0333629 A1
(43) Pub. Date: Dec. 19, 2013

(54) REPLACEABLE CAT SCRATCHER

(71) Applicant: Sara Paculdo, San Francisco, CA (US)

(72) Inventor: Sara Paculdo, San Francisco, CA (US)

(73) Assignee: WORLDWISE, INC., San Rafael, CA (US)

(21) Appl. No.: 13/523,479

(22) Filed: Jun. 14, 2012

(51) Int. Cl. A01K 15/02

(52) U.S. Cl. 119/706

(57) ABSTRACT

A cat scratching system for providing a surface suitable for cat scratching. The system includes a rigid support and a scratching medium. The rigid support has a support surface for receiving the cat scratching medium and the cat scratching medium has a first surface and a second surface, the first surface suitable for scratching and the second surface to be received by the rigid support. The support surface and second surface have complimentary releasable connectors facilitating the selective attachment of the scratching medium to the rigid support.

### TECHNICAL FIELD

The present invention involves a cat scratching system for introducing cat scratching surfaces of various types to a domestic cat. The system includes a rigid support and connectors to enable various cat scratching surfaces to be releasabley connected to the support for renewing the system as cat scratching surfaces erode or to modify the cat scratching surfaces to maintain interest by the using cat.

### BACKGROUND OF THE INVENTION

It is well recognized that domestic cats crave scratching as part of their natural instinctive character. If a dedicated scratching surface is not provided, domestic cats will generally satisfy their need to scratch by turning to furniture, curtains and other articles which can be substantially damaged as a consequence. Oftentimes, pet cats will not only climb over furniture, especially upholstered chairs and sofas, but will use such furniture and carpeting to condition their claws through deliberate and repeated clawing, pulling and tearing actions specifically with their forepaws. As noted, this clawing activity appears to be an irresistible natural impulse for cats and can be the source of great aggravation to the pet owner.

There are a number of vendors of pet and pet related products that have offered implements dedicated to alleviating the need of a cat to scratch. These include cat scratching posts and pads comprised of such things as carpet, sisal, seagrass, rope and cardboard. Most often, a single scratching surface is permanently affixed to a substrate providing rigidity and form to the cat scratching surface. As the scratching surface is degraded through repeated use, the entire composite structure must be discarded as the support for the scratching surface has no utility other than to support the surface available for scratching. Also, cat scratchers traditionally are characterized as having a scratching surface which cannot be altered. As a consequence, cats oftentime lose interest in such products as a lack of interchangeability can result in boredom. Further, many cats are picky about surfaces that they may prefer to satisfy their need for scratching. In fact, such preferences may very well change over time. As most cat owners may not be aware of their cat's preferences, the present invention allows the pet owner to exchange scratching surfaces to determine which of such surfaces has the greatest appeal without the need to invest in a completely new scratcher.

It is thus an object of the present invention to provide a cat scratching system which eliminates those limitations of the prior art as discussed above.

This object will be more readily appreciated when considering the following disclosure and appended claims.

### SUMMARY OF THE INVENTION

A cat scratching system for providing a surface suitable for cat scratching. The system includes a rigid support and a scratching medium. The rigid support has a support surface for receiving the cat scratching medium and the cat scratching medium has a first surface and a second surface, the first surface suitable for scratching and the second surface to be received by the rigid support. The support surface and second surface have complimentary releasable connectors facilitating the selective attachment of the scratching medium to the rigid support.

### BRIEF DESCRIPTION OF THE FIGURES

FIG. 1 is an exploded perspective view of the replaceable cat scratcher of the present invention.

FIG. 2 are top plan view of scratching media useful for practicing the present invention.

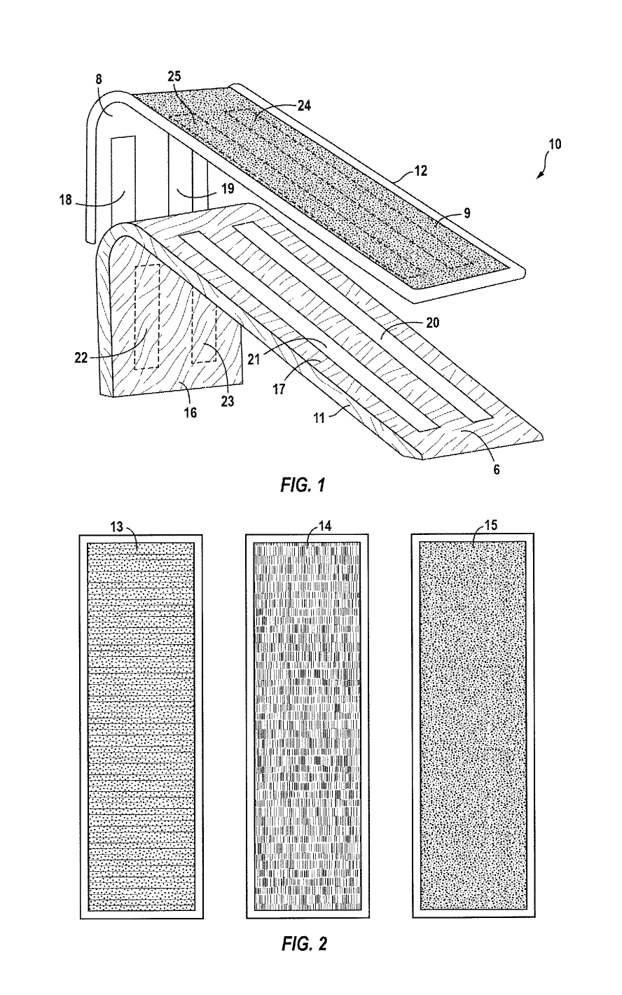

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

The primary purposes of the present invention are to provide a scratching system is which robust, likely to be used extensively by a pet cat and which represents an economical solution to the use of such products. By virtue of the present system, the scratching medium which is the portion of the system typically degraded, is capable of being replaced without the need to discard its support which can be an expensive component of such a system. In addition, by providing for a replaceable scratching medium, different scratching surfaces can be interchangeably employed with the same rigid support thus maintaining the interest of a pet using this invention and to enable a pet owner to determine scratcher preferences.

In turning to the figures, cat scratching system 10 is depicted for providing a surface suitable for cat scratching. System 10 comprises rigid support 11 and scratching medium 12, 13, 14 and 15.

Scratching medium 12-15 is characterized by having first surface 9 and second surface 8, the first surface being suitable for scratching and the second surface to be received by rigid support 11.

It is noted that when cat scratching medium 12 is placed over rigid support 11 that support surface 17 of rigid support 11 and cat scratching medium 12 are substantially coextensive with one another. Although rigid support 11 can be sized slightly larger than scratching medium 12, they are generally of the same size and geometry such that when connected with one another they appear to the using pet cat as a singular article.

Cat scratching medium 12-15 can be composed of known materials generally used for this purpose. They include, for example, sisal, carpet and seagrass. Again, other known scratching materials can be employed without departing from the spirit and scope of the present invention.

It is contemplated that scratching medium 12 be only selectively attached to rigid support 11 such that scratching medium 12 can be selectively removed from top surface 17 of rigid support 11 to facilitate its removal once worn or to interchange it with other cat scratching media to maintain the interest level of a using cat. Ideally, strips of hook and loop fasteners 18, 19, 20, 21, 22, 23, 24 and 25 are applied to second surface 8 of scratching medium 12 and support surface 17 of rigid support 11.

Although rigid support 11 can take on differing shapes while remaining within the spirit and scope of the present invention, ideally, rigid support 11 is characterized such that when placed upon a horizontal surface, first segment 16 thereof extends substantially vertically therefrom transitioning into a second segment 6 extending diagonally and downwardly away from first segment 16 to the horizontal surface. This creates an extended ramp composed of second segment 6 creating an excellent planar and elongated scratching surface for a using pet. In addition, the area created beneath rigid support 11 can act as a shelter oftentimes sought after by a pet cat as cats, by their very nature, occasionally require seclusion as part of their daily routine.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A cat scratching system for providing a surface suitable for cat scratching, said system comprising a rigid support and a scratching medium, said rigid support having a support surface for receiving said cat scratching medium and said cat scratching medium having a first surface and a second surface, said first surface suitable for scratching and the second surface to be received by said rigid support, said support surface and said second surface having complimentary releasable connectors for facilitating the selective attachment of said scratching medium to said rigid support.

2. The cat scratching system of claim 1 wherein said complimentary releasable connectors comprise hook and loop fasteners.

3. The cat scratching system of claim 1 wherein said scratching medium comprises a member selected from the group consisting of carpet, sisal and seagrass.

4. The cat scratching system of claim 1 wherein said scratching medium and said support surface are sized such that said scratching medium is substantially coextensive with said support surface.

5. The cat scratching system of claim 1 wherein said rigid support is characterized such that when placed upon a horizontal surface, a first segment thereof extends substantially vertically therefrom transitioning to a second segment extending diagonally and downwardly away from said first segment to said horizontal surface.

6. The cat scratching system of claim 5 wherein said scratching medium is substantially coextensive with said first and second segments.

7. The cat scratching system of claim 6 wherein said releasable connectors are placed upon both of said first and second segments.
